(19) United States
(12) Patent Application Publication
(10) Pub. No.: US 2020/0265343 A1
(43) Pub. Date: Aug. 20, 2020

(54) DIGITAL TICKETING TO DETERMINE SEAT ALLOCATION

(71) Applicant: INTERNATIONAL BUSINESS MACHINES CORPORATION, Armonk, NY (US)

(72) Inventors: Laurence John Plant, North Balwyn (AU); Christopher John Butler, Hawthorn East (AU); Cameron Pollock, Melbourne (AU); Katrina Louise Barnett, Melbourne (AU); Leon Gouletsas, South Yarra (AU)

(21) Appl. No.: 16/277,946

(22) Filed: Feb. 15, 2019

(51) Int. Cl. G06Q 10/02; G06Q 30/06

(52) U.S. Cl. CPC G06Q 10/02; G06Q 30/0635

(57) ABSTRACT

A method for determining seat allocation. The method includes receiving a purchase order by a first user for one or more seats at an event, wherein the purchase order includes at least one or more of the following: a preferred seating area, a proposed venue, a proposed date range for the event, a proposed time of day for the event, and a proposed number of seats within a group. The method further includes generating one or more digital tickets based on the received purchase order, wherein each of the one or more digital tickets is linked to the received purchase order by the first user. The method further includes determining seat allocation at the event based on the generated one or more digital tickets, and allocating one or more traditional tickets based on the determined seat allocation at the event.

### BACKGROUND

Embodiments of the present invention relate generally to the field of computing and more particularly to data processing and determining seat allocation for an event.

Oftentimes, customers make reservations in advance for one or more seats at concerts, sporting events, transportation services (e.g., airplanes, buses, etc.), hotels, and other venue-based activities.

### SUMMARY

Embodiments of the invention include a method, computer program product, and system, for determining seat allocation for an event.

According to an embodiment, a method for determining seat allocation, wherein the method includes receiving one or more purchase orders by a first user for one or more seats at an event, and generating one or more digital tickets based on the received one or more purchase orders, wherein each of the one or more digital tickets is linked to the received one or more purchase orders by the first user. The method further includes determining seat allocation at the event based on the generated one or more digital tickets, and allocating one or more traditional tickets based on the determined seat allocation at the event.

A computer program product, according to an embodiment of the invention, includes a tangible storage device having program code embodied therewith. The program code is executable by a processor of a computer to perform a method. The method includes receiving one or more purchase orders by a first user for one or more seats at an event, and generating one or more digital tickets based on the received one or more purchase orders, wherein each of the one or more digital tickets is linked to the received one or more purchase orders by the first user. The method further includes determining seat allocation at the event based on the generated one or more digital tickets, and allocating one or more traditional tickets based on the determined seat allocation at the event.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes receiving one or more purchase orders by a first user for one or more seats at an event, and generating one or more digital tickets based on the received one or more purchase orders, wherein each of the one or more digital tickets is linked to the received one or more purchase orders by the first user. The method further includes determining seat allocation at the event based on the generated one or more digital tickets, and allocating one or more traditional tickets based on the determined seat allocation at the event.

### BRIEF DESCRIPTION OF THE SEVERAL VIEWS OF THE DRAWINGS

FIG. 1 illustrates a digital ticketing computing environment, in accordance with an embodiment of the present invention.

FIG. 2 is a flowchart illustrating the operation of a digital ticketing system, in accordance with an embodiment of the present invention.

FIG. 3 is a diagram graphically illustrating the hardware components of the digital ticketing computing environment of FIG. 1, in accordance with an embodiment of the present invention.

FIG. 4 depicts a cloud computing environment, in accordance with an embodiment of the present invention.

FIG. 5 depicts abstraction model layers of the illustrative cloud computing environment of FIG. 4, in accordance with an embodiment of the present invention.

### DETAILED DESCRIPTION

Currently, if you want to go to a concert, sporting event, movie, or any other venue experience that includes ticket sales for a seat, with friends, then everyone needs to commit at the same time and typically one person buys the batch of tickets on behalf of the group in order to ensure that everyone can sit together. The reason is because seats are allocated at the time of purchase, and ticket reservations for a venue may fill up quickly, thereby excluding others who may later want to join in with their friends and family, or sit next to their friends and family at the venue.

Embodiments of the present invention recognize that since seats for an event are typically allocated at the time of purchase, getting everyone in the group to agree, and perhaps also pay up-front, may create delays in the group ticket purchase thereby causing the group to miss out on good seats. Furthermore, additional friends and family may want to join the group after the tickets have already been purchased, but cannot sit next to the group if they purchase their tickets later because the seats have already been reserved.

Additionally, event planners may book a location for an event and then realize that the event has garnered interest well beyond the seating capacity of the booked location. This error may prove costly for potential ticket revenue.

The present invention may be offered to many other types of customers aside from events management companies (i.e., event ticket purchases). Some examples may include restaurants, cruise lines, vacation packages, tourism companies, hotel chains, and airlines just to name a few. Additionally, the present invention may be used in conjunction with blockchain technology for managing legitimate ticket purchases, thereby protecting consumers from fraudulent ticket sales.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

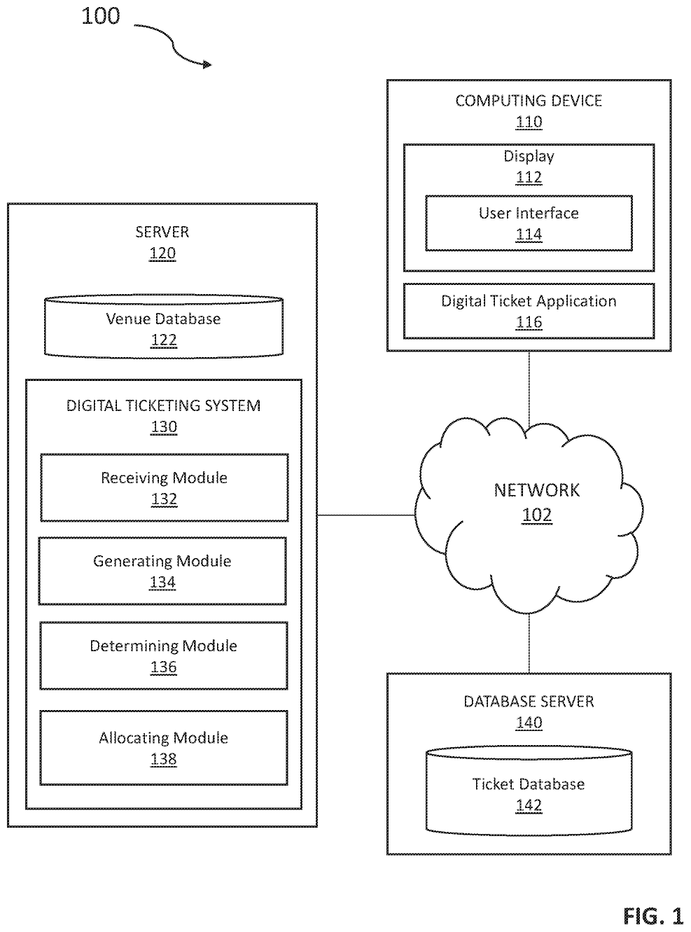

FIG. 1 illustrates digital ticketing computing environment 100, in accordance with an embodiment of the present invention. Digital ticketing computing environment 100 includes computing device 110, server 120, and database server 140 all connected via network 102. The setup in FIG. 1 represents an example embodiment configuration for the present invention, and is not limited to the depicted setup in order to derive benefit from the present invention.

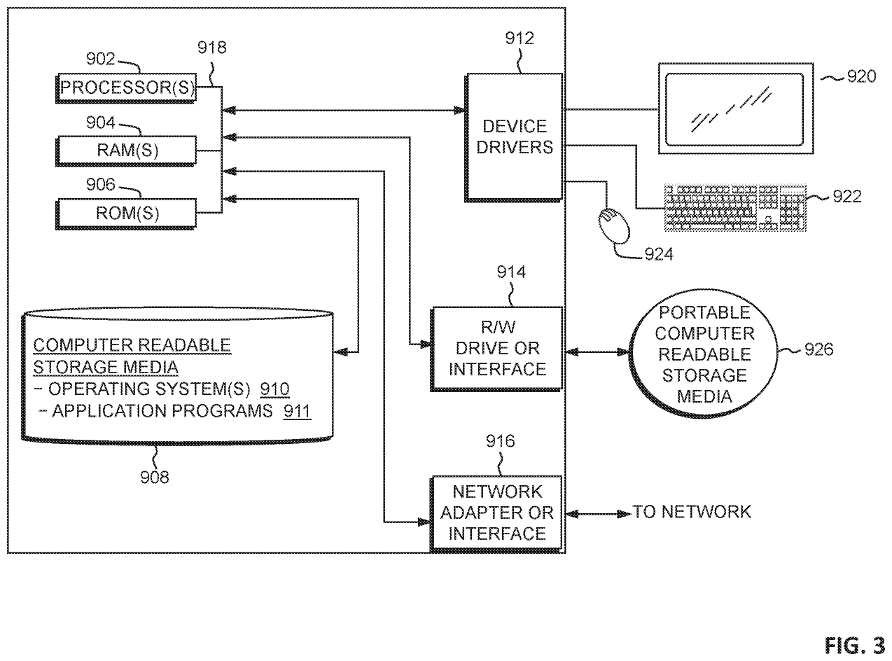

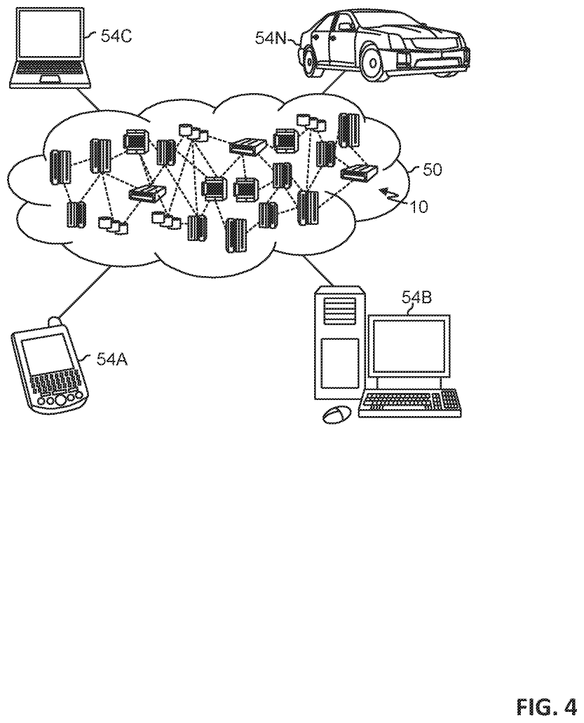

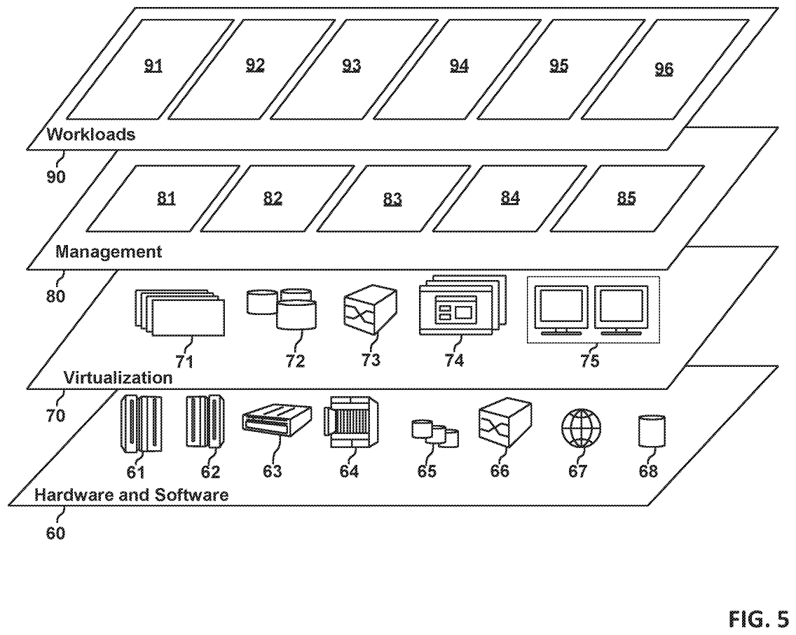

In an exemplary embodiment, computing device 110 contains display 112, user interface 114, and digital ticket application 116. In various embodiments, computing device 110 may be a laptop computer, tablet computer, netbook computer, personal computer (PC), a desktop computer, a personal digital assistant (PDA), a smart phone, or any programmable electronic device capable of communicating with server 120 and database server 140 via network 102. Computing device 110 may include internal and external hardware components, as depicted and described in further detail below with reference to FIG. 3. In other embodiments, computing device 110 may be implemented in a cloud computing environment, as described in relation to FIGS. 4 and 5. Computing device 110 may also have wireless connectivity capabilities allowing it to communicate with server 120 and database server 140, as well as other computers or servers over network 102.

In an exemplary embodiment, display 112 receives data from digital ticket application 116 and digital ticketing system 130. Display 112 may be connectively coupled to hardware components, such as those depicted in FIG. 3, for displaying user input and/or received data.

In an exemplary embodiment, user interface 114 may be a computer program that allows a user to interact with computing device 110 and other connected devices via network 102. For example, user interface 114 may be a graphical user interface (GUI). In addition to comprising a computer program, user interface 114 may be connectively coupled to hardware components, such as those depicted in FIG. 3, for receiving user input. In an exemplary embodiment, user interface 114 may be a web browser, however in other embodiments user interface 114 may be a different program capable of receiving user interaction and communicating with other devices.

In an exemplary embodiment, digital ticket application 116 may be a web browser or other computer program, on computing device 110, that is capable of accessing third party ticket website vendor platforms for the purpose of viewing, selecting, reserving and/or purchasing tickets for a show, movie, competition, performance, sporting event, or any other live or recorded performance for a specific future date range, time range, and geographic location. In additional embodiments, digital ticket application 116 may also be capable of accessing vendor platforms to make reservations for a hotel, motel, bed and breakfast, airline, bus, train, or any other venue that is capable of reserving a seat, a room, or a specific space for one or more customers for a specific future date range, time range, and geographic location if applicable.

In exemplary embodiments, digital ticket application 116 may be capable of accepting reservations for a specific event and/or vendor over the course of a pre-determined period of time. In exemplary embodiments, reservations for a specific event and/or vendor may include user preferences such as seating location (e.g., orchestra, mezzanine, balcony, first class, business class, aisle seat, window seat, penthouse, 2 bedroom, etc.), user-provided physical characteristics of the user, and any other preferences that a user may disclose to assist in determining an appropriate seating location for the user. In exemplary embodiments, any and all information is only collected and saved with prior knowledge and consent of the user. Digital ticket application 116 may be capable of transmitting received user input information to digital ticketing system 130 via network 102. In alternative embodiments, digital ticket application 116 may contain a seating chart for a proposed venue, whereby a user may be capable of selecting a desired seat or seating location.

With continued reference to FIG. 1, server 120 contains venue database 122 and digital ticketing system 130, and may be a laptop computer, tablet computer, netbook computer, personal computer (PC), a desktop computer, a personal digital assistant (PDA), a smart phone, or any programmable electronic device capable of communicating with computing device 110 and database server 140 via network 102. While server 120 is shown as a single device, in other embodiments, server 120 may be comprised of a cluster or plurality of computing devices, working together or working separately. In a preferred embodiment, server 120 may be implemented in a cloud computing environment, as described in relation to FIGS. 4 and 5.

In an exemplary embodiment, venue database 122 is a database storage that contains the seating charts, floorplans, maps, and other viewable materials for various venues (e.g., planes, trains, hotels, theatres, concert halls, stadiums, and so forth) and locations. For example, venue database 122 may include the seating chart for a hockey game at a particular venue as well as the seating chart for a basketball game at the same venue. In additional embodiments, venue database 122 may include the floorplans for a hotel space depicting one bedroom units, two bedroom units, and so forth. In exemplary embodiments, venue database 122 is capable of being updated dynamically based on information received from application 116, digital ticketing system 130, and/or by an authorized third party.

In an exemplary embodiment, digital ticketing system 130 contains instruction sets, executable by a processor, which may be described using a set of functional modules. The functional modules of digital ticketing system 130 may include receiving module 132, generating module 134, determining module 136, and allocating module 138.

In an exemplary embodiment, database server 140 includes ticket database 142 and may be a laptop computer, tablet computer, netbook computer, personal computer (PC), a desktop computer, a personal digital assistant (PDA), a smart phone, a server, or any programmable electronic device capable of communicating with computing device 110 and server 120 via network 102. While database server 140 is shown as a single device, in other embodiments, database server 140 may be comprised of a cluster or plurality of computing devices, working together or working separately.

In an exemplary embodiment, ticket database 142 may include generated digital tickets, stored as data objects, according to various criteria. For example, generated digital tickets may be organized according to a specific event, a user ID, a date range, and so forth. A data object for a digital ticket may reflect a purchaser's preferences for seating allocation, together with preferred dates to attend the event, etc., which may be stored as follows in ticket database 142: <userID; mezzanine; four_tix; June7,14,21; Anytown>. The present invention is not limited to the examples of data objects provided herein, but may further include additional formats or methods to store information from a user, known to one of ordinary skill in the art.

In an exemplary embodiment, ticket database 142 may be organized according to a venue location (e.g., Washington D.C., New York City, San Francisco), an event category (e.g., ballet, sporting event, concert), venue name, a group of users that prefer to sit next to each other, or any other category or organization deemed most useful for the invention to be utilized.

In further exemplary embodiments, ticket database 142 may further store ticket purchase history of a user, or a group of users, thereby collecting event and seating preferences of a user, or a group of users, over time. Prior to collecting any information about a user, or group of users, consent and knowledge from the user would be requested and authorized.

In various embodiments, ticket database 142 may be capable of being stored on server 120 or computing device 110, as a separate database.

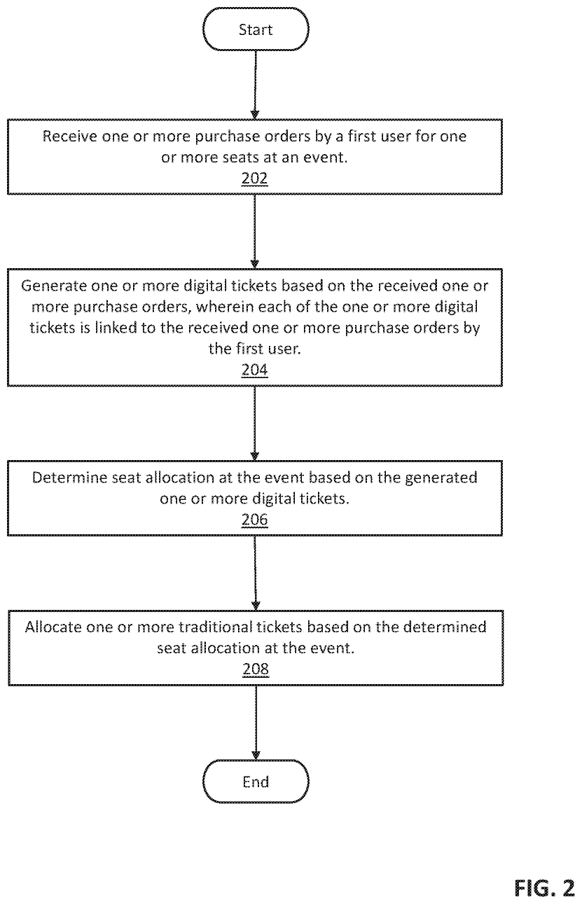

FIG. 2 is a flowchart illustrating the operation of digital ticketing system 130, in accordance with an embodiment of the present invention.

Referring now to FIGS. 1 and 2, receiving module 132 includes a set of programming instructions in digital ticketing system 130. The set of programming instructions is executable by a processor. Receiving module 132 receives one or more purchase orders by a first user for one or more seats at an event (step 202). In exemplary embodiments, one or more purchase orders may include at least one or more of the following: a preferred seating area, a proposed venue, a proposed date range for the event, a proposed time of day for the event, and a proposed number of seats within a group. In further embodiments, additional criteria known to one of ordinary skill in the art may be included, or excluded, from a purchase order.

In exemplary embodiments, receiving module 132 may receive a proposed seating chart, or floorplan, for a venue from venue database 122, ticket database 142, a database stored locally on computing device 110, or directly from digital ticketing application 116.

In exemplary embodiments, receiving module 132 may receive purchase order data from digital ticketing application 116 via network 102.

With reference to an illustrative example, Bob wants to take his extended family to a local summer concert, however not everyone in his extended family can currently commit to buying tickets. Bob does not want to miss out on getting tickets to the summer concert, so he goes online and places a purchase order for four tickets (for himself, his wife, and two kids) via digital ticketing application 116, and tells his extended family to purchase their own tickets at their convenience. Bob's purchase order includes a preferred range of dates to attend the summer concert (any Sunday in June), a total number of seats (4), and a preference to sit as close to the stage as possible.

With continued reference to FIGS. 1 and 2, generating module 134 includes a set of programming instructions in digital ticketing system 130. The set of programming instructions is executable by a processor. Generating module 134 generates one or more digital tickets based on the received one or more purchase orders, wherein each of the one or more digital tickets is linked to the received one or more purchase orders by the first user (step 204).

In exemplary embodiments, a digital ticket may be sold to a customer prior to a venue being booked, a seat allocated, or even a date locked in for a specific event or reservation. In various embodiments, the digital ticket logs one or more purchase orders for various users in a database (i.e., ticket database 142) for a preferred event. For example, the digital ticket may contain various bits of data reflecting a user's purchase order, which may be stored as a data object, such as <userID; mezzanine; four_tix; June7,14,21; Anytown> in ticket database 142, for example. In various embodiments, digital ticket data objects may not necessarily be limited to a specific data structure but may vary depending on the intent of the data collection and the amount of data collected from a user.

In exemplary embodiments, digital ticketing system 130 may receive one or more additional purchase orders by one or more additional users, within a fixed window of time of the received one or more purchase orders, for one or more additional seats at the event, wherein the received one or more additional purchase orders include a request to sit next to the first user from the one or more purchase orders. Digital ticketing system 130 may further group the one or more additional users with the first user, based on the request, and update the generated one or more digital tickets based on the received one or more additional purchase orders.

In alternative embodiments, digital ticketing system 130 may be capable of splitting groups. For example, digital ticketing system 130 may receive a request from the one or more users within the group, holding a digital ticket, to no longer sit with the group. In this instance, generating module 134 may update the digital ticket of the one or more users within the group, and disassociate the seating location preference of the one or more users to be outside of the group.

In exemplary embodiments, a fixed window of time may be pre-configured for any set amount of time, from as little as a few hours or less to as long as a few months or more. Possible benefits of having a fixed window of time for potential purchase orders for an event may be to gauge the popularity of an event to determine an appropriate venue (e.g., actual customer sales plus a forecast for additional sales based on a predictive analytic model), to maximize group booking arrangements, to provide flexible seating allocation for customers who buy tickets at various times but want to sit next to a specific person or group, and to provide seating allocation to one or more groups of people based on known behavior types (e.g., keeping two separate fan bases apart in order to improve crowd control).

In exemplary embodiments, digital ticketing system 130 may transmit the request to the first user for approval. In exemplary embodiments, a user may opt-in to receive seating request notifications from other users. If the first user declines the request of a second user to sit next to the first user, or to the group of the first user, then digital ticketing system 130 may be capable of relaying the disapproval to the second user, or simply deny the request.

In additional embodiments, a hotel chain with multiple properties in a particular geographic location may benefit by selling digital tickets to prospective customers. For example, the customer may purchase a digital ticket via digital ticket application 116 and thereby commit to stay in one of the hotels in a particular city for a specific date range. The hotel, in turn, may allocate a room to the customer in one of their hotels in the city based on yield optimization. In this example, the hotel remains flexible in their room bookings and the customer is guaranteed a room in one of the hotels in the city for the specified date range.

In further embodiments, digital ticketing system 130 may be capable of receiving an airplane seat purchase order, wherein the airplane seat purchase order comprises a destination city, a departure city, a range of dates and times for travel, and a seat preference. Digital ticketing system 130 may notify a user of an available seat on an airplane within a specific date and time range, and request an approval of the user for the available seat on the airplane, via a digital ticket application 116 alert, electronic mail, telephone call, or any other method known to one of ordinary skill in the art.

Referring back to the illustrative example above, generating module 134 generates four digital tickets based on Bob's received purchase order. Bob's digital tickets are then saved in ticket database 142 for the length of the online sale period of summer concert tickets, together with other customers' digital tickets for the event, in order to gauge the popularity of the event for proper venue determination, as well as to assign appropriate seating to the customers based on seating requests and preferences. Bob's extended family can conveniently purchase tickets after Bob places his order and not have to worry about being locked out of a set of seats next to Bob's family. They would simply request to sit next to Bob when placing their purchase order. In turn, the seating request may be transmitted to Bob via e-mail, alert, text message, or in some other fashion known to one of ordinary skill in the art, and Bob simply approves the request.

With continued reference to FIGS. 1 and 2, determining module 136 includes a set of programming instructions in digital ticketing system 130. The set of programming instructions is executable by a processor. Determining module 136 determines seat allocation at the event based on the generated one or more digital tickets (step 206).

In exemplary embodiments, determining module 136 may be capable of determining a venue for the event based on the generated one or more digital tickets, and determining seat allocation based on the determined venue. Determining module 136 may be capable of determining an appropriate venue by considering the number of digital tickets generated (e.g., sold) for an event and selecting a venue seating chart from venue database 122 that contains a seating capacity closest to the number of digital tickets generated for a specific type of event (e.g., music, sports, magic show, and so forth). In further embodiments, additional considerations for selecting an appropriate venue may be considered such as acoustics, availability for a specific date and time range, seating capacity, scheduling availability, and so forth.

In alternative embodiments, an event may be cancelled based on a lack of digital tickets being sold, reflecting a lack of interest in the event.

In exemplary embodiments, determining module 136 may determine seat allocation by linking the one or more seats, at the determined venue, to each of the generated one or more digital tickets based on one or more user preferences. In various embodiments, one or more user preferences may be disclosed with the purchase order, as discussed above. Additionally, in various embodiments, the generated digital ticket that contains the user's purchaser order details (i.e., stored as a data object in ticket database 142), may be dynamically adjusted by digital ticketing system 130 based on future requests to sit next to the user, cancelled by a user, transferred to another customer, or refunded to the user by the vendor in the event of event cancellation.

Additionally, event promotors may benefit from gauging digital ticket sales by selecting an appropriate venue that matches digital sales. For example, under the existing methods, a concert promoter may book a venue for an up-and-coming artist at a medium size venue. If ticket sales surge based on the artist's continued rise in popularity, the concert promotor has lost out on potential additional revenue if he had booked at a larger venue. By contrast, digital ticketing system 130 would select an appropriate venue that corresponds to the number of generated digital tickets, thereby maximizing ticket revenue.

Referring back to the illustrative example above, determining module 136 determines seat allocation at the summer concert based on the totality of the generated digital tickets. Bob, his family, and his extended family are all seated together (even though they purchased their tickets weeks apart) two rows from the stage (as requested) in a venue that comes as close as possible to match the number of generated digital tickets. The customers are satisfied, the vendors are satisfied, the concert promotors are satisfied, and everyone who purchased a digital ticket is able to attend the event.

With continued reference to FIGS. 1 and 2, allocating module 138 includes a set of programming instructions in digital ticketing system 130. The set of programming instructions is executable by a processor. Allocating module 138 allocates one or more traditional tickets based on the determined seat allocation at the event (step 208).

In exemplary embodiments, allocating module 138 may e-mail the one or more traditional tickets to a user that contains a barcode for scanning at the event. Alternatively, allocating module 138 may send a printable version of the one or more traditional tickets to the user to print via email, or send by paper mail.

In alternative embodiments, allocating module 138 may determine an allocation of the one or more seats, in the event of an overbooking, based on one or more of the following criteria: a lottery (e.g., at random), a loyalty determination (e.g., gold, silver, or platinum members get first priority), and an auction (e.g., customers may be provided with an option to pay more for their ticket in order to attend).

In further embodiments, in the case of an overbooking, customers that paid for a digital ticket may have the option to receive a full refund, or a credit for a future event.

With continued reference to the illustrative example above, Bob receives an e-mail containing four traditional tickets for the summer concert, which Bob prints out and is able to bring to the concert venue for admission. Bob's extended family receives a notification that there was an overbooking for the concert, and that people who purchased tickets within one week prior to the summer concert may not be able to be afforded a seat and will receive a full refund. However, since Bob's extended family are gold members at the community performing arts center, the notice additionally advises that Bob's extended family have received priority and have been afforded the requested number of tickets to the concert.

FIG. 3 is a block diagram depicting components of a computing device in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Computing device of FIG. 3 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910 and one or more application programs 911, such as digital ticketing system 130, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device of FIG. 3 may also include a R/W drive or interface 914 to read from and write to one or more portable computer readable storage media 926. Application programs 911 on the computing device may be stored on one or more of the portable computer readable storage media 926, read via the respective R/W drive or interface 914 and loaded into the respective computer readable storage media 908.

Computing device of FIG. 3 may also include a network adapter or interface 916, such as a TCP/IP adapter card or wireless communication adapter (such as a 4G wireless communication adapter using OFDMA technology). Application programs 911 on computing device of FIG. 3 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device of FIG. 3 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and analytics services 96, including those described in connection with FIGS. 1-5.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for determining seat allocation, the method comprising:
receiving one or more purchase orders by a first user for one or more seats at an event;
generating one or more digital tickets based on the received one or more purchase orders, wherein each of the one or more digital tickets is linked to the received one or more purchase orders by the first user;
determining seat allocation at the event based on the generated one or more digital tickets; and
allocating one or more traditional tickets based on the determined seat allocation at the event.

2. The computer-implemented method of claim 1, wherein the one or more purchase orders comprise at least one or more of the following: a preferred seating area, a proposed venue, a proposed date range for the event, a proposed time of day for the event, and a proposed number of seats within a group.

3. The computer-implemented method of claim 1, further comprising:
receiving one or more additional purchase orders by one or more additional users, within a fixed window of time of the received one or more purchase orders, for one or more additional seats at the event,
wherein the received one or more additional purchase orders include a request to sit next to the first user from the one or more purchase orders;
grouping the one or more additional users with the first user, based on the request; and
updating the generated one or more digital tickets based on the received one or more additional purchase orders.

4. The computer-implemented method of claim 3, further comprising:
transmitting the request to the first user for approval.

5. The computer-implemented method of claim 1, further comprising:
determining a venue for the event based on the generated one or more digital tickets; and
determining seat allocation based on the determined venue.

6. The computer-implemented method of claim 5, wherein determining seat allocation further comprises:
linking the one or more seats, at the determined venue, to each of the generated one or more digital tickets based on one or more user preferences.

7. The computer-implemented method of claim 6, wherein allocating one or more traditional tickets, further comprises:
determining an allocation of the one or more seats, in the event of an overbooking, based on one or more of the following criteria: a lottery, a loyalty determination, and an auction.

8. The computer-implemented method of claim 1, further comprising:
receiving an airplane seat purchase order, wherein the airplane seat purchase order comprises a destination city, a departure city, a range of dates and times for travel, and a seat preference;
notifying a user of an available seat on an airplane within a specific date and time range; and
requesting an approval of the user for the available seat on the airplane.

9. A computer program product, comprising a computer-readable tangible storage device having program code embodied therewith, the program code executable by a processor of a computer to perform a method, the method comprising:
receiving one or more purchase orders by a first user for one or more seats at an event;
generating one or more digital tickets based on the received one or more purchase orders, wherein each of the one or more digital tickets is linked to the received one or more purchase orders by the first user;
determining seat allocation at the event based on the generated one or more digital tickets; and
allocating one or more traditional tickets based on the determined seat allocation at the event.

10. The computer program product of claim 9, wherein the one or more purchase orders comprise at least one or more of the following: a preferred seating area, a proposed venue, a proposed date range for the event, a proposed time of day for the event, and a proposed number of seats within a group.

11. The computer program product of claim 9, wherein the program code, further executable by the processor of the computer to perform the method, the method further comprising:
receiving one or more additional purchase orders by one or more additional users, within a fixed window of time of the received one or more purchase orders, for one or more additional seats at the event,
wherein the received one or more additional purchase orders include a request to sit next to the first user from the one or more purchase orders;
grouping the one or more additional users with the first user, based on the request; and
updating the generated one or more digital tickets based on the received one or more additional purchase orders.

12. The computer program product of claim 11, wherein the program code, further executable by the processor of the computer to perform the method, the method further comprising:
transmitting the request to the first user for approval.

13. The computer program product of claim 9, wherein the program code, further executable by the processor of the computer to perform the method, the method further comprising:
determining a venue for the event based on the generated one or more digital tickets; and
determining seat allocation based on the determined venue.

14. The computer program product of claim 13, wherein the program code, further executable by the processor of the computer to determine seat allocation further comprises:
linking the one or more seats, at the determined venue, to each of the generated one or more digital tickets based on one or more user preferences.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
receiving one or more purchase orders by a first user for one or more seats at an event;
generating one or more digital tickets based on the received one or more purchase orders, wherein each of the one or more digital tickets is linked to the received one or more purchase orders by the first user;
determining seat allocation at the event based on the generated one or more digital tickets; and
allocating one or more traditional tickets based on the determined seat allocation at the event.

16. The computer system of claim 15, wherein the one or more purchase orders comprise at least one or more of the following: a preferred seating area, a proposed venue, a proposed date range for the event, a proposed time of day for the event, and a proposed number of seats within a group.

17. The computer system of claim 15, wherein the program instructions, further executable by the one or more processors, further comprise program instructions for:
receiving one or more additional purchase orders by one or more additional users, within a fixed window of time of the received one or more purchase orders, for one or more additional seats at the event,
wherein the received one or more additional purchase orders include a request to sit next to the first user from the one or more purchase orders;
grouping the one or more additional users with the first user, based on the request; and
updating the generated one or more digital tickets based on the received one or more additional purchase orders.

18. The computer system of claim 17, wherein the program instructions, further executable by the one or more processors, further comprise program instructions for:
transmitting the request to the first user for approval.

19. The computer system of claim 15, wherein the program instructions, further executable by the one or more processors, further comprise program instructions for:
determining a venue for the event based on the generated one or more digital tickets; and
determining seat allocation based on the determined venue.

20. The computer system of claim 19, wherein determining seat allocation further comprises program instructions, further executable by the one or more processors, for:
linking the one or more seats, at the determined venue, to each of the generated one or more digital tickets based on one or more user preferences.
